(19) United States
(12) Patent Application Publication
(10) Pub. No.: US 2021/0390512 A1
(43) Pub. Date: Dec. 16, 2021

(54) NUUBI JOB SEARCH SYSTEM AND METHOD

(71) Applicant: Benjamin S Cockerham, Land O Lakes, FL (US)

(72) Inventor: Benjamin S Cockerham, Land O Lakes, FL (US)

(21) Appl. No.: 16/898,237

(22) Filed: Jun. 10, 2020

(51) Int. Cl. G06Q 10/10; H04N 7/14

(52) U.S. Cl. CPC G06Q 10/1053; H04N 7/147

(57) ABSTRACT

A system and method for providing an online applicant a resume profile with job searching and interviewing is disclosed. The system includes a web interface, a profile editor, a profile search engine, a messenger, a calendar-scheduler, and a web video interviewer. The The user profile provides applicant information to prospective employers. The applicant information includes name and impression information education information, skills information, experience information, contact information, and reference information. The applicant information components may utilize text, image, hyperlink, and video and audio data clips.

### TECHNICAL FIELD

This application relates in general to a system and method for providing job posting and searching, and more specifically, to a system and method for providing an online applicant a resume profile with job searching and interviewing.

### BACKGROUND

Every job candidate relies on a resume to find a position; however the resume has not changed over time. Candidates use a resume to show their years of education, years of work experience, different career achievements, their technical skills, etc. With so many different qualifications to list on a single piece of paper, a standard resume does not give a prospective employer a good impression of who the candidate truly is. A resume is the “first” first impression and might just be the most important first impression a candidate will make. Ordinary resumes simply do not give candidates the opportunity and the resources to truly sell their qualifications and their skills to employers. The candidate needs a resume that allows him/her the ability to truly differentiate themselves from their competition.

At the same time, companies all around the world spend time, resources, and money to find the perfect candidate to fill open job positions. Hiring a new employee is an investment of funds and resources that every company must make. These companies currently do not have access to a tool to help ensure a candidate is qualified while making the entire hiring process simple and efficient. At the same time, companies do not have a “one-stop shop” candidate finder.

Therefore, a need exists for a new mechanism for candidates to create their own unique manner to communicate their education, experiences, skills, and desire to become an asset to a company. Companies also benefit from an easy and simple candidate screener. The present invention attempts to address the limitations of existing systems using the principles and example embodiments disclosed herein.

### SUMMARY

In accordance with the present invention, the above and other problems are solved by providing a system and method for providing job posting and searching, and more specifically, to a system and method for providing an online applicant resume profile with job searching and interviewing, according to the principles and example embodiments disclosed herein.

In one embodiment, the present invention is a system for providing an online applicant resume profile with job searching and interviewing. The system includes a web interface, a profile editor, a profile search engine, a messenger, a calendar-scheduler, and a web video interviewer. The user profile provides applicant information to prospective employers. The applicant information includes name and impression information education information, skills information, experience information, contact information, and reference information. The applicant information components may utilize text, image, hyperlink, and video and audio data clips.

In another embodiment, the present invention is a method for providing an online applicant resume profile with job searching and interviewing. The method creates a multimedia introduction of the online applicant on a web based computing system, creates one or more applicant information pages on the web based computing system, receives a prospective employer contact via the web based computing system, creates one or more follow up reminders on the web based computing system, when the prospective employer contact includes an interview request, schedules an online video interview, when the web based computing system triggers one or more follow up reminders, takes action on the one or more reminders on the web based computing system, and terminates all outstanding reminders on the web based computing system when accepting an offer, receiving a decline, and declining an offer.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides an online applicant a resume profile with job searching and interviewing according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-g illustrate an example embodiment of a system for providing an online applicant a resume profile with job searching and interviewing according to the present invention.

FIGS. 4a-b illustrate another example embodiment of a system for providing an online applicant a resume profile with job searching and interviewing according to the present invention.

FIG. 5 illustrates a computing system of software components providing an online applicant a resume profile with job searching and interviewing according to the present invention.

FIG. 6a illustrates an example flowchart corresponding to a method performed by software components providing an online applicant a resume profile with job searching and interviewing according to the present invention.

### DETAILED DESCRIPTION

This application relates in general to a system and method for providing job posting and searching, and more specifically, to a system and method for providing an online applicant a resume profile with job searching and interviewing, according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The terms “customer,” “client,” and “user” refer to an entity, e.g. a human, using the Nuubi Job Search System and Method including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

The term “invention” or “present invention” refers to the invention being applied for via the patent application with the title “Nuubi Job Search System and Method.” Invention may be used interchangeably with web job search system.

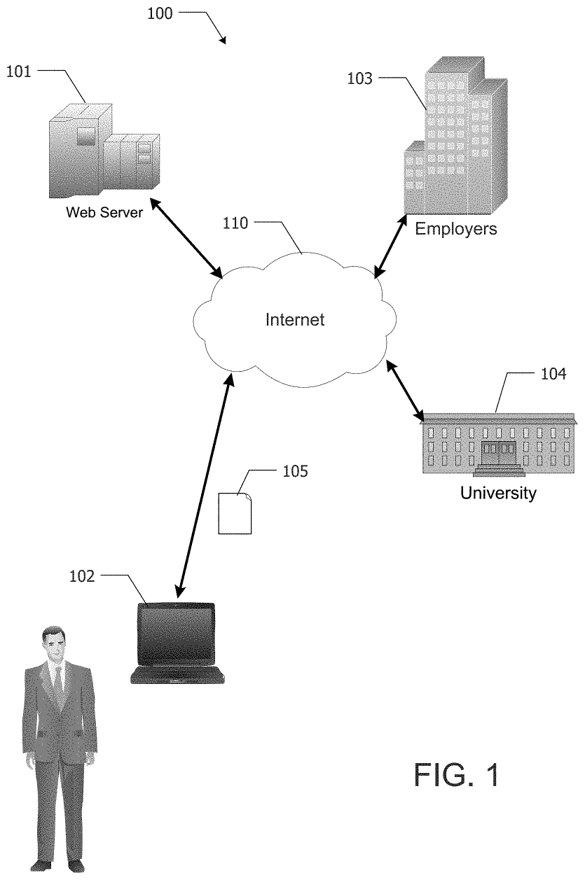

In general, the present disclosure relates to a system and method for providing job searching. To better understand the present invention, FIG. 1 illustrates an example embodiment for a system that provides an online applicant a resume profile with job searching and interviewing according to the present invention. The present invention is a system 100 to help people get their dream jobs, but to also provide a simple and cost effective resource for employers 103. The present invention attempts to create a new and improved, modern-day resume 105 that gives the job candidate a true opportunity to express their experience, achievements, education, skills, and most importantly, their personality.

Job hunting can cause a candidate a great deal of stress, while hiring the right candidate for a position can cost a company a great deal of time and money. The system 100 attempts to create a stress-free experience for the candidate as he/she searches a web site 101 for available positions that match their skills and career goals, while creating an efficient resource for companies 103. Job hunters access the web server 101 using their computing devices 102 over the Internet 110 to create an online resume 105 as well as search for available positions. The employers 103 may be matched with available candidates meeting a minimum set of qualifications to help the interested parties find each other and begin the recruitment process. Additionally, the web server 101 may reach out to universities 104, past employers, and the like to verify a candidate's qualifications when the resume 105 is first created. Any items that are listed on the resume that are successfully verified may be marked accordingly with both the candidate and the prospective employer having confidence that a successful match between applicant and employer may quickly occur using the system 100.

The candidates and employers 103 may interact using the system 100 by exchanging email messages, by engaging in online video interviews, and exchanges of documents and related materials as the recruitment process occurs. Job offers and explanations of available benefits also may be exchanged as the process reaches its conclusion.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals via wireless signals such as Bluetooth™, wireless fidelity, infrared, Wi-Fi or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 101 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. On the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device or any combination thereof. In at least some aspects, at least some of the features or functionalities of the various aspects disclosed herein may be implemented in one or more virtualized computing environments (e g, network computing clouds, virtual machines hosted on one or more physical computing machines or other appropriate virtual environments).

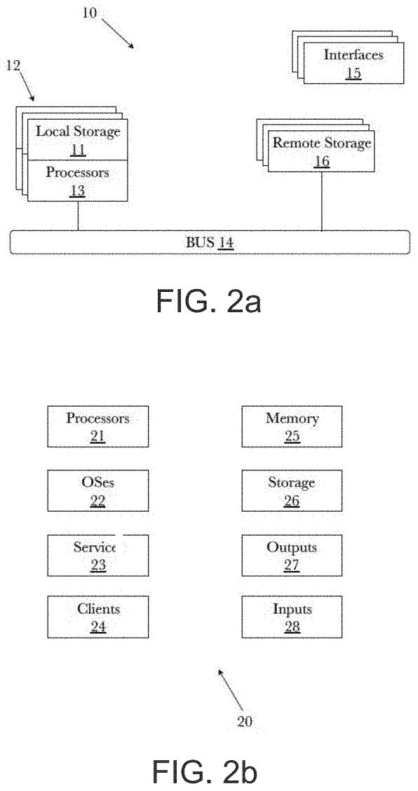

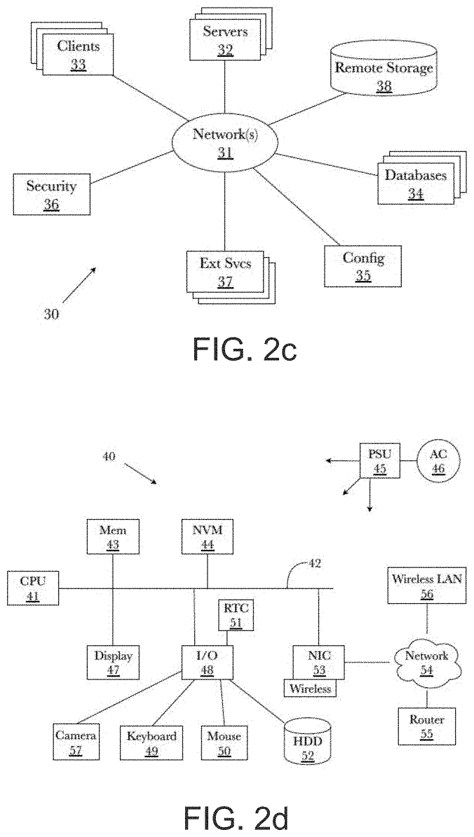

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, a computing device 10 includes one or more central processing units (CPU) 12, one or more interfaces 15, and one or more buses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as for example, a version of MICROSOFT WINDOWS™ operating system, APPLE macOS™ or iOS™ operating systems, some variety of the LINUX™ operating system, ANDROID™ operating system or the like. In many cases, one or more shared services 23 may be operable in a system 20, and may be useful for providing common services to client applications 24. Services 23 may, for example, be WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing the client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to a bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

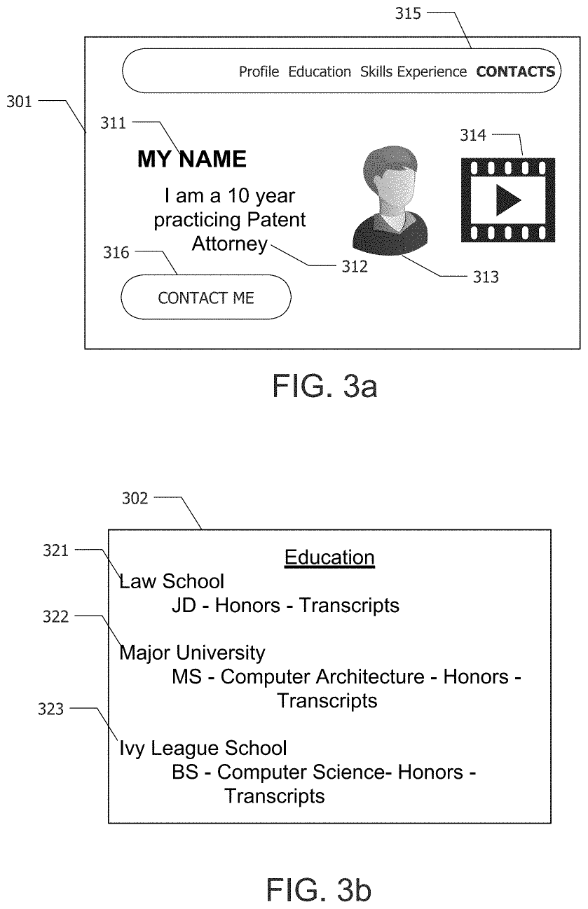

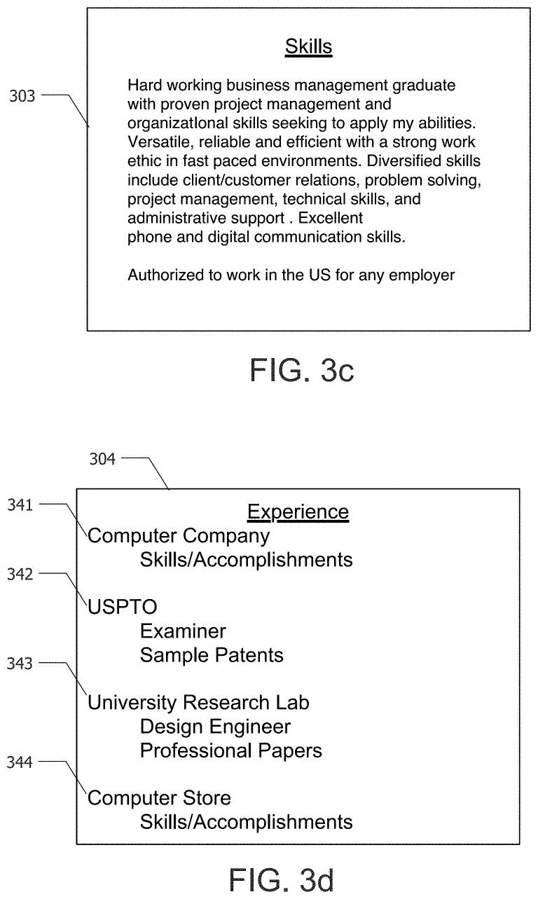

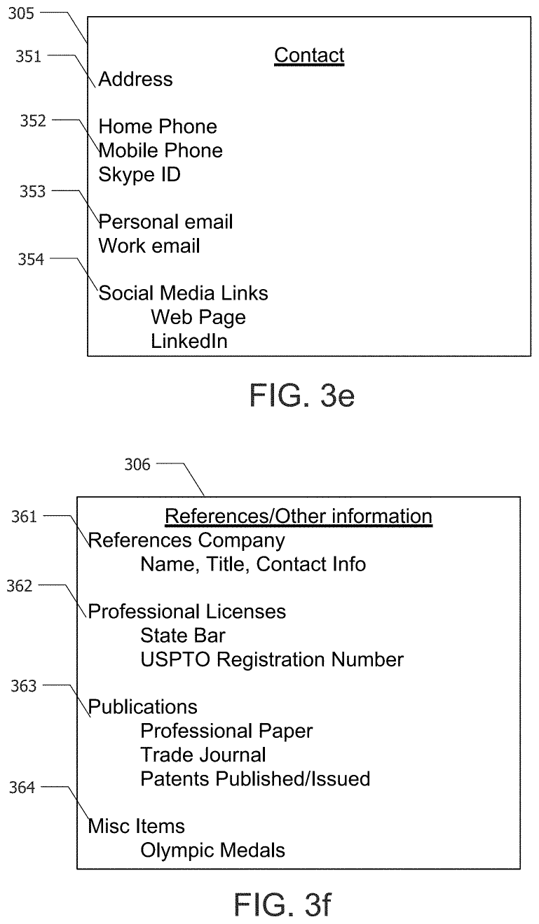

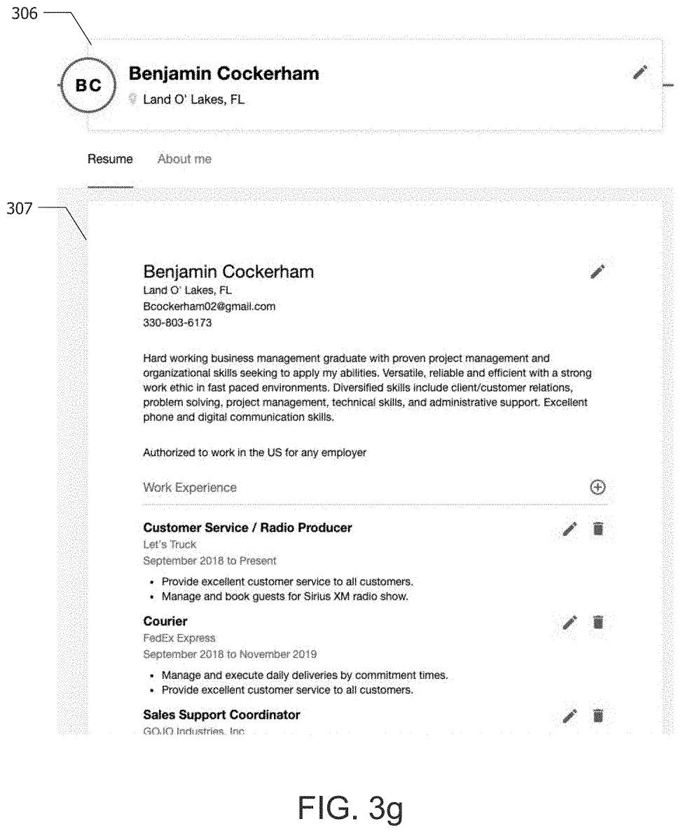

FIGS. 3a-g illustrate an example embodiment of a system for providing an online applicant a resume profile with job searching and interviewing according to the present invention. The online resume and profile 301 presents a series of separate pages shown in FIGS. 3a-f that may be navigated using a navigation bar 315 containing a set of URL web links. These various separate pages contain applicant information that comprises name and impression information education information, skills information, experience information, contact information, and reference information These separate web pages may include a profile page 301, an education page 302, a skill page 303, an experiences page 304, and a contact page 305. An applicant may also include other pages to completely present their abilities and interest in the available position however they wish. These pages may be based upon customizable templates that are tailored to match the individual applicant.

For example, the profile page 301 of FIG. 3a may present an applicant's name 311, a short description 312, a photograph 313, a short video introduction 314 and a button 315 to initiate contact with the applicant. Each of these items may be created by the individual applicant and added to present a story regarding how the applicant may be an asset to an employer when hired.

FIG. 3b shows an education page 302 that provides information regarding one or more degrees 321-323 earned by the applicant. This information may include the name of the university or school, the degree earned, and any honors or other useful information. The education page 302 may also provide URL links to the applicant's other materials such as published papers, presentations, essays, and the like. Other awards and related information may also be documented in text and or URL links. A complete explanation of the educational experiences and achievements may be presented along with links to assist in validating these achievements all in one place.

FIG. 3c shows a skills page 303 that provides information regarding the candidate's skill set. The applicant may list any and all skills that they wish to highlight for prospective employers. A complete explanation of the skills experiences and related achievements may present along with links to assist in validating these achievements all in one place.

FIG. 3d shows an experiences page 304 that provides information regarding one or more prior positions 341-344 held by the applicant. This information may include the name of the position, the name of the employer, dates or location of the position, salary, and any other useful information. The experiences page 304 may also provide URL links to other materials such as published papers, presentations, and the like of the applicant. Other awards and related information may also be documented in text and or URL links. A complete explanation of professional and work experiences may be presented along with links to assist in validating these achievements all in one place.

FIG. 3e shows a contact page 305 that provides information regarding one or more means for a prospective employer to contact the applicant. This information may include a home or mailing address, one or more telephone numbers, one or more email addresses, one or more online identification pages such as may be found on a home page or on social media pages, and any other useful contact information. Each of these data items may also be presented as a URL link that may directly connect a representative of the prospective employer to an applicant at one or more of these addresses. A complete listing of the contact methods that may be used to reach the applicant may be presented along with links.

FIG. 3f shows a reference/other information page 306 that provides any additional information that the applicant may regard as being potentially useful to a prospective employer. This information may include the name and contact information of named references who may not be listed on the experiences page 304. The reference/other information page 306 may also provide URL links to other materials that the applicant wishes to share with the prospective employer.

All of these pages may present information using text, photos, video clips, links to documents and other materials to provide the applicant with a unique way to describe him or herself, their skills, their goals, and their abilities to contribute to the success of the prospective employers.

FIG. 3g shows a complete example of one resume page. The applicant's page includes a name header 306 and a resume body 305 containing all of the data from FIGS. 3a-f above. This data may contain hyperlinks to other data, images, videos, and the like.

The candidate may also be able purchase an assessment that is assigned to each qualification or skill that they choose to list on their resume. Once they complete the assessment, they will receive a verification symbol that indicates that the candidate is in fact qualified in that skill.

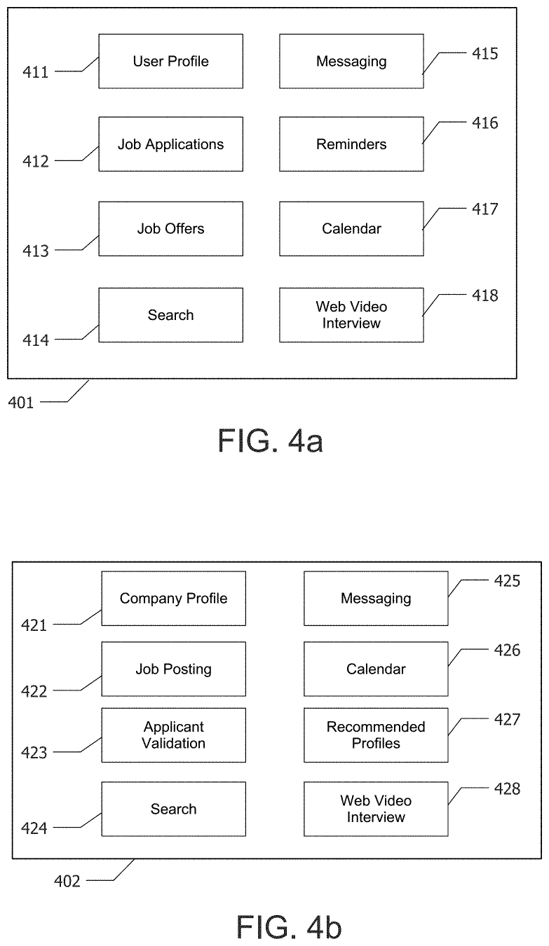

FIGS. 4a-b illustrate another example embodiment of a system for providing an online applicant a resume profile with job searching and interviewing according to the present invention. The system 100 provides applicants with a set of additional features to aid in the job search and interviewing process. FIG. 4a shows a set of web pages 411-418 used by the applicants as they interact with the system 100. These web pages include a user profile page 411, a job application page 412, a job offer page 413, a job search page 414, a messaging page 415, a reminders page 416, an applicant calendar page 417, and a web video interview page 418.

The user profile page 411 provides an applicant with an ability to create, view, edit, and remove an online resume used as part of the applicant's job search. All of the page editing tools including access to page templates, photograph and video clip capture and editing, text entry and editing, and file upload and editing may be available to applicants via the user profile page.

The job application page 412 allows the applicant to submit an application for an available job position. This page may permit the applicant to submit a link to the online profile/result, to submit other requested materials and documents, and to submit cover letters and requests for information to a prospective employer as part of the application process. Each time the applicant submits a job application, a related job application page 412 may be created. All of the communications, scheduled events, deadlines, job offers, and related responses may be found in one place to help the applicant track the status of each application while under consideration.

The job offer page 413 allows both the applicant and a hiring company to organize and locate all of the materials associated with a particular job offer. Any questions or follow up from either party may be found in an easily reviewed location. All of the terms of the job offer, such as the salary, benefits, start date, location, and moving reimbursement are located in one place.

The job search page 414 provides a search term entry page that generates a set of search results for an applicant. Particular search terms may be saved for reuse, submitted to periodic automated execution in which newly found search results are provided to the applicant by text message, email message, and application notification on the system 100. The search results typically include links to a particular job listing shown on employer web pages that include a link to start an application submission for the position.

The messaging page 415 provides both applicants and representatives of prospective employers with a messaging mechanism to communicate with each other directly from the system 100. The messages that are sent and received may be linked to and available from other communications platforms including email servers, SMS services, and they like. The messaging page 415 and the corresponding company messaging page 425 also maintain a set of copies of all communications between the parties in one place to permit each of them to review all past interactions throughout the job application and interview process.

The reminders page 416 and the corresponding company reminder page 426 provide both applicants and representatives of prospective employers with a set of reminders that an action or response is generally expected from that party at any particular point in the job application and interview process. These reminders may be generated automatically by the system 100 or may be defined by the relevant party to make sure that any desired follow up action occurs in a timely manner.

The applicant calendar page 417 and the corresponding company reminder page 427 provide both applicants and representatives of prospective employers with a calendar of scheduled interactions that are made during the job application and interview process. Each of these pages may include dates and times of all scheduled events to permit each party with an ability to easily determine a time when both parties are available for future contact as well as review when past events occurred. These calendar pages 417, 427 may also be synced with remote 3d party calendar servers to permit individuals to ensure that these events are readily viewable, created, and edited from platforms used by the individuals.

The web video interview page 418 and the corresponding company reminder page 428 allow the parties to schedule and conduct a video interview remotely from within the system 100 that provides the parties with simultaneous access to all of the related information regarding the applicant, the company, the job listing, and the past communications during the interview. The video interview may also function as a means of making contact similar to a telephone call while capturing and recording the interaction for later review.

In addition to the applicant's resume, the system 100 also provides useful features to prospective employers. Companies all around the world spend time, resources, and money to find the perfect candidate to fill open job positions. Companies that use the system 100 will have the ability to use a variety of resources to keep the candidate search and hire process simple and efficient. FIG. 4b shows a set of web pages 421-428 used by the prospective employers as they interact with the system 100. These web pages include a company profile page 421, a job posting page 422, an applicant validation page 423, a resume search page 424, a messaging page 425a company calendar page 426, recommended profile page 427, and a web video interview page 428.

The company profile page 421 permits a prospective employer to describe the company, its needs, its culture, and any other information desired to be shared when describing the benefits of working for the organization. The company profile page 421 provides a mechanism for selling applicants on the benefits of accepting a job offer. The company profile page 421 may also define expectations, needs, and company culture to assist in ensuring that an applicant and available position are a good match for each other.

The job posting page 422 provides a prospective employer with an ability to create, view, edit, and remove an available job listing made available as part of the applicant's job search. All of the page editing tools, including access to page templates, photograph and video clip capture and editing, text entry and editing, and file upload and editing, may be available to employers via the company profile page.

The applicant validation page 423 provides a prospective employer with a mechanism to request that an entry on an applicant's user profile/resume be validated. The validation request may be submitted to the applicant for providing supplemental information. The validation request, when appropriate and authorized by the parties, also may be submitted to a third party, such as a college, to request and receive documentation associated with an entry on a user profile/resume.

The resume search page 424 provides a search term entry page that generates a set of search results for an available applicant sought by an employer. Particular search terms may be saved for reuse or submitted to periodic automated execution in which newly found search results are provided to the applicant by text message, email message, and application notification on the system 100. The search results typically include links to a particular applicant profile/resume page with a link to start an application for the position.

The messaging page 425, the reminders page 426, and the web video interview page 428 perform the same functions described above regarding the applicant as is provided to the representative of the prospective employer when interacting with the applicant.

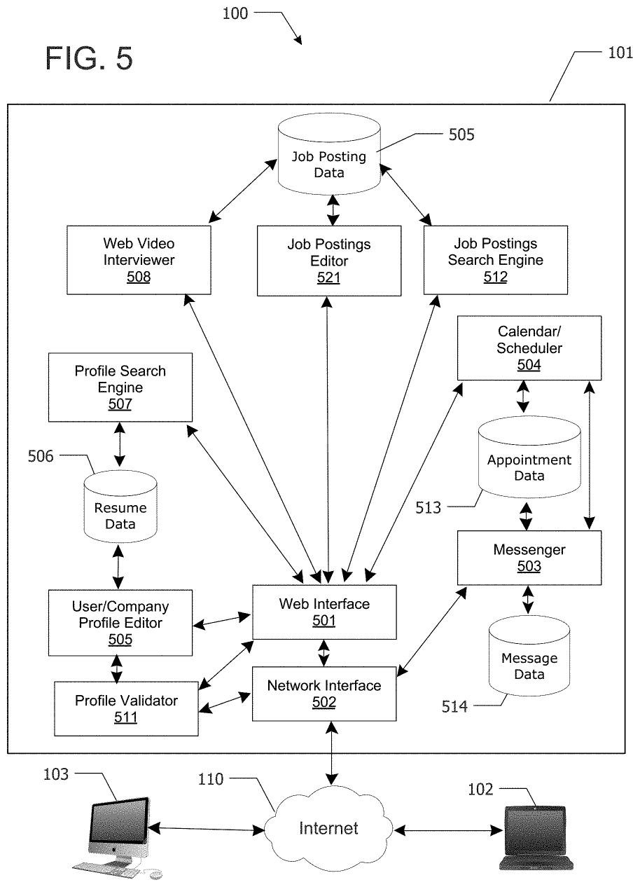

FIG. 5 illustrates a computing system of software components providing an online applicant a resume profile with job searching and interviewing according to the present invention. A system 100 is constructed using a web server 101 that an applicant 102 and a prospective employer 103 communicate on using an ordinary web browser. The web server 101 is constructed using a set of interconnected processing elements 501-508, 511-512, 521 that access data stores 505-5-6513-514. The set of interconnected processing elements comprise a web interface 501, network interface 502, messenger 503, calendar/scheduler 504, user/company profile editor 505, profile search engine 507, web video interviewer 508, profile validator 511, job posting search engine 512, and job posting editor 521.

The web interface 501 receives a Hypertext Transfer Protocol (HTTP) web page request from the web browser from the applicant's computer 102 and the prospective employer's computer 103 to generate a response that is sent back to the web browser. The prospective employer and the online applicant also may communicate with the web interface using a mobile application running on a local computing device, the local computing device comprises a smartphone, a tablet, a laptop, and a desktop computer. The web interface 501 sends the web pages back using data in specified in a Hypertext Markup Language (HTML) data format.

The network interface 502 connects the web server 101 to the Internet 110 to send and receive communication from applicants and prospective employers. The network interface 502 performs all necessary data formatting, data packet creation, data encryption for security, and data transmission and reception when the web server 101 communicates with other processing systems disclosed herein. The network interface 502 is also responsible for ensuring reception of any communications to other computing systems and to log any errors or attempts to hack into the various data stores.

The messenger 503 provides both applicants and representatives of prospective employers with a messaging mechanism to communicate with each other directly from the system 100. The messages that are sent and received may be linked to and available from other communications platforms including email servers, SMS services, and they like. The messenger 503 supports the applicant messaging page 415 and the corresponding company messaging page, and 425 also maintains copies of all communications between the parties in one place to permit each of them to review all past interactions throughout the job application and interview process.

The calendar/scheduler 504 provides both applicants and representatives of prospective employers with a calendar of scheduled interactions that are made during the job application and interview process. The calendar/scheduler 504 supports the applicant's calendar page 417 and the company's calendar page 427. Each of these pages may include dates and times of all scheduled events to provide each party with an ability to easily determine a time when both parties are available for future contact as well as review when past events occurred. The calendar/scheduler 504 also supports syncing these calendar pages 417, 427 with remote third party calendar servers to ensure that these events are readily viewable, created, and edited from platforms readily used by the interested parties.

The user/company profile editor 505 supports the user profile page 411 and company profile page 421 that provide applicants and companies with an ability to create, view, edit, and remove an online profile used as part of the applicant's job search. All of the page editing tools including access to page templates, photograph and video clip capture and editing, text entry and editing, and file upload and editing may be available to applicants via the user profile page.

The profile search engine 507 supports both the recommended profile page 427 and the resume search page 424 and both provide a search term entry page that generates a set of search results for available applicants and employers. Particular search terms may be saved for reuse and submitted to periodic automated execution in which newly found search results are provided to the applicant by text message, email message, and application notification on the system 100. The search results typically include links to a particular applicant profile/resume page with a link to start an application for the position.

The web video interviewer 508 supports the web video interview page 418, and the corresponding company reminder page 428, as they allow the parties to schedule and conduct a video interview remotely from within the system 100, and provides the parties with simultaneous access to all of the related information regarding the applicant, the company, the job listing, and the past communications during the interview. The video interview may also function as a means of making contact similar to a telephone call while capturing and recording the interaction for later review. As noted above, the prospective employer and the online applicant may communicate with the web interface using a web browser and a mobile application running on a local computing device, the local computing device comprises a smartphone, a tablet, a laptop, and a desktop computer. The web video interviewer may provide the prospective employer and the online applicant with IP addresses to initiate a video connection between the mobile applications or web browsers.

The profile validator 511 supports the applicant validation page 423 to provide a prospective employer with a mechanism to request that an entry on an applicant's user profile/resume be validated. The validation request may be submitted to the applicant for providing supplemental information. The validation request, when appropriate and authorized by the parties, may also be submitted to a third party, such as a college, to request and receive documentation associated with an entry on a user profile/resume.

The job posting search engine 512 supports the job search page 414 and the recommended profile page 427 to provide a search term entry page that generates a set of search results for an applicant and company. Particular search terms may be saved for reuse and submitted to periodic automated execution in which newly found search results are provided to the applicant by text message, email message, and application notification on the system 100. The search results typically include links to particular job listing with a link to start an application for the position

The job posting editor 521 supports the job posting page 422 to provide a prospective employer with an ability to create, view, edit, and remove an available job listing from an applicant's job search. All of the page editing tools including access to page templates, photograph and video clip capture and editing, text entry and editing, and file upload and editing may be available to an employer via the company profile page

The data stores comprise a job posting data store 505, a resume data store 506, an appointment data store 513, and a message data store 514. The job posting data store 505 maintains a database containing available job postings that may be searched by an applicant using the job search page 413 and searched by the system 100 to recommend applicants to companies using the recommended profile page 427. The profile data store 506 maintains a database of all company profiles and all applicant profile/resume pages. The profile data store 506 supports the user/company profile editor 505, the profile validator 511, and the profile search engine 507. The appointment data store 513 maintains a database of all events generated and supported by the system 100. All entries into the user and company calendars generated and maintained by the calendar/scheduler 504, as well as any reminders associated with these events and displayed by the applicant reminder page 416.

The message data store 514 maintains a database used by the messenger 503 that provides both applicants and representatives of prospective employers with a messaging mechanism to communicate with each other directly from the system 100. The messages that are sent and received may be linked to and available from other communications platforms including email servers, SMS services, and they like. The messenger data store 514 maintains a set of copies of all communications between the parties in one place to permit each of them to review all past interactions throughout the job application and interview process.

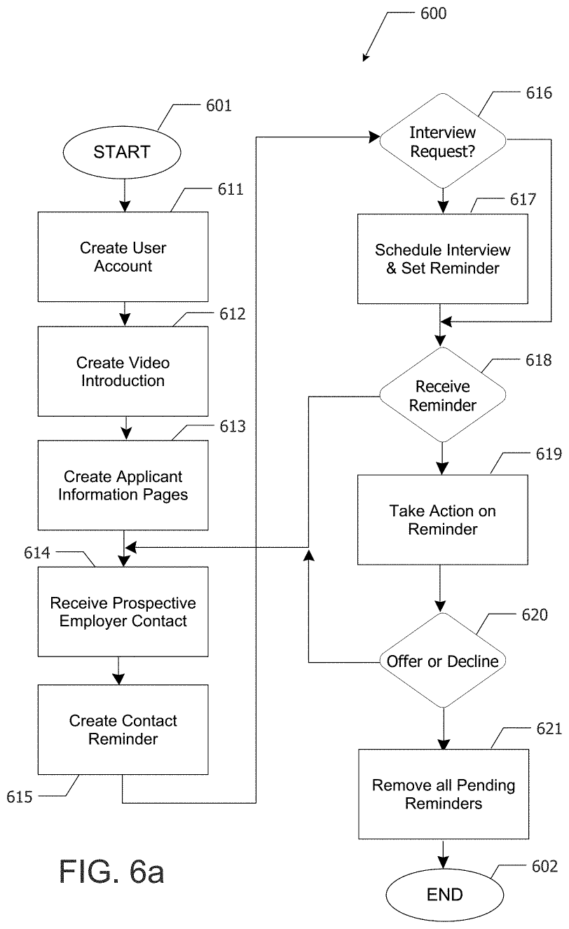

FIG. 6a illustrates an example flowchart corresponding to a method performed by software components providing an online applicant a resume profile with job searching and interviewing according to the present invention. The process 600 begins 601 when an online applicant creates a user account on the systemin step 611 for providing an online applicant a resume profile with job searching and interviewing. In step 612, the online applicant creates a multimedia introduction for display on the resume profile. The multimedia introduction may include a photograph, text, a hyperlink, and a video clip of the online applicant.

Step 613 creates one or more additional applicant information pages that are part of the online applicant's profile. These one or more additional applicant information pages may include in part the profile page 301, the education page 302, the skill page 303, the experiences page 304, and the contact page 305. An applicant may also include other pages to completely present their abilities and interest in the available position however they wish. These pages may be based upon customizable templates that are tailored to match the individual applicant. \

The online applicant receives contact from a prospective employer in step 614 and creates one or more follow up reminders on the online system in step 615. Test step 616 determines if the prospective employer contact is an interview request, and if so, the interview is scheduled and an additional reminder is set in step 617; otherwise, the process proceeds directly to test step 618.

Test step 618 determines whether one or more of the previously set reminders have been triggered, and if not, the process returns to step 614 to await additional prospective employer contact. When test step 618 determines that one or more of the previously set reminders have been triggered, step 619 takes action on the reminder. Test step 620 determines whether the online applicant is ending contact with the prospective employer, and if not, the processing returns to step 614 to await additional prospective employer contact. When test step 620 determines that the online applicant is ending contact with the prospective employer, step 621 removes all pending reminders related to the prospective employer and the process ends 602. The online applicant may end contact with the prospective employer when accepting an offer, receiving a decline, and declining an offer.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed:

1. A system for providing an online applicant a resume profile with job searching and interviewing, the system comprising:
a web interface for communicating with a prospective employer and the online applicant;
a profile editor for permitting the online applicant to create and modify an online provide providing the prospective employers with applicant information, the applicant information comprises name and impression information education information, skills information, experience information, contact information, and reference information;
a profile search engine for searching user profiles to find possible candidates for positions by prospective employers;
a messenger for permitting the online applicant to exchange information with the prospective employer;
a calendar-scheduler for creating a calendar of events and reminders relating to contact between the online applicant and the prospective employer; and
a web video interviewer for conducting an online video interview between the online applicant and the prospective employer;
wherein the applicant information may also comprise text, image, hyperlink, and video and audio data clips.

2. The system according to claim 1, wherein the system further comprises:
a profile validator for.

3. The system according to claim 1, wherein the prospective employer and the online applicant communicate with the web interface using a web browser.

4. The system according to claim 1, wherein the prospective employer and the online applicant communicate with the web interface using a mobile application running on a local computing device, the local computing device comprises a smartphone, a tablet, a laptop, and a desktop computer.

5. The system according to claim 4, wherein the web video interviewer provides the prospective employer and the online applicant with IP addresses to initiate a video connection between the mobile applications.

6. A method for providing an online applicant a resume profile with job searching and interviewing, the method comprising:
creating a multimedia introduction of the online applicant on a web based computing system;
creating one or more applicant information pages on the web based computing system;
receiving a prospective employer contact via the web based computing system;
creating one or more follow up reminders on the web based computing system;
when the prospective employer contact includes an interview request, scheduling an online video interview;
when the web based computing system triggers one or more follow up reminders, taking action on the one or more reminders on the web based computing system; and
terminating all outstanding reminders on the web based computing system when accepting an offer, receiving a decline, and declining an offer.

7. The method according to claim 6, wherein the method further comprises:
creating a user account on the web based computing system;
validating applicant information on the one or more applicant pages; and
indicating on the one or more applicant pages applicant information that is validated.

8. The method according to claim 7, wherein the method further comprises:
logging into the web based computing system each time the online applicant communicates with the prospective employer.

9. The method according to claim 7, where an indication that applicant data is validated comprises a hyperlink to online information containing documentation regarding the validated applicant information.

10. The method according to claim 9, wherein the hyperlink to online information addresses a third party web server.
